(19) United States
(12) Patent Application Publication
(10) Pub. No.: US 2025/0242584 A1
(43) Pub. Date: Jul. 31, 2025

(54) LIQUID DROPLET EJECTING APPARATUS AND LIQUID DROPLET EJECTING METHOD

(71) Applicant: BROTHER KOGYO KABUSHIKI KAISHA, Nagoya (JP)

(72) Inventors: Wataru NARUSE, Nagoya (JP); Jeongbin LEE, Nagoya (JP); Hiroto SUGAHARA, Ama (JP); Taro NAGANO, Nagoya (JP)

(73) Assignee: BROTHER KOGYO KABUSHIKI KAISHA, Nagoya (JP)

(21) Appl. No.: 19/041,698

(22) Filed: Jan. 30, 2025

(30) Foreign Application Priority Data
Jan. 31, 2024 (JP) 2024-013553

(51) Int. Cl. B41J 2/045; B41J 2/14

(52) U.S. Cl. CPC B41J 2/04573; B41J 2/04525; B41J 2/04581; B41J 2/14233; B41J 2002/14459; B41J 2002/14491

(57) ABSTRACT

A liquid droplet ejecting apparatus includes: a channel member; piezoelectric elements; and a controller. The channel member has a common channel, individual channels each communicating with one of nozzles. The individual channels include first to fourth individual channels, the common channel has first to fourth connection ports to which the first to fourth individual channels are connected, respectively. A distance between the first and second connection ports is different from a distance between the third and fourth connection ports. The controller drives first and third piezoelectric elements included in the piezoelectric elements and corresponding, respectively, to first and third nozzles included in the nozzles at a first timing, and drives second and fourth piezoelectric elements included in the piezoelectric elements and corresponding, respectively, to second and fourth nozzles included in the nozzles at a second timing delayed from the first timing by a predetermined amount of time.

### REFERENCE TO RELATED APPLICATIONS

This application claims priority from Japanese Patent Application No. 2024-013553 filed on Jan. 31, 2024. The entire content of the priority application is incorporated herein by reference.

### BACKGROUND ART

A known liquid ejecting apparatus includes nozzles ejecting liquid, actuators each corresponding to one of the nozzles, a liquid supplying part communicating with the nozzles, and a driving signal supplying part. In this liquid ejecting apparatus, the nozzles are disposed in an array form in a row direction and a column direction. In the same driving cycle, the driving signal supplying part delays, by a predetermined amount of time, a timing of supplying a driving signal with respect to each of actuators which correspond, respectively, to nozzles which are adjacent to each other in the row direction; and the driving signal supplying part delays, by a predetermined amount of time, a timing of supplying the driving signal with respect to each of actuators which correspond, respectively, to nozzles which are adjacent to each other in the column direction. With this, the pressure vibration between the nozzles adjacent to each other in the row direction and between the nozzles adjacent to each other in the column direction can be canceled, thereby reducing the deterioration in the print quality due to the crosstalk.

### SUMMARY

However, as the printing speed increases, the driving cycle of the actuators is required to be shortened, and the kinds of delay times which can be set within the same driving cycle are limited. Further, in a case where a plurality of kinds of delay times are set within the same driving cycle, the driving control also becomes complicated. For this reason, the delay time of the driving timing of the actuators is preferably made uniform (one type).

In the above-described liquid ejecting apparatus, in a case where the delay time in the driving timing of the actuators is made uniform (one type), the influence by the crosstalk, such as the variation in the velocity and/or the volume of liquid droplet and the change in the separation state of liquid droplet, will be uniform among the nozzles regarding which the ejecting timing is delayed. Further, in a case where the nozzles influenced uniformly by the crosstalk are periodically aligned in the row direction and the column direction, any periodic unevenness might occur in the result of printing, depending on a printing pattern.

An object of the present disclosure is to provide a liquid droplet ejecting apparatus and a liquid droplet ejecting method each of which is capable of reducing the occurrence of periodic unevenness in the printing result while uniformizing the delay time in the driving timing of the driving elements.

According to a first aspect of the present teaching, a liquid droplet ejecting apparatus is provided. The liquid ejecting apparatus includes: a channel member having an ejection surface in which nozzles are opened, individual channels, and a common channel; driving elements fixed to the channel member; and a controller electrically connected to the driving elements. The nozzles include a first nozzle and a second nozzle which are adjacent to each other along a first direction parallel to the ejection surface, and a third nozzle and a fourth nozzle which are adjacent to each other along a second direction parallel to the ejection surface and crossing the first direction. The individual channels include a first individual channel communicating with the first nozzle, a second individual channel communicating with the second nozzle, a third individual channel communicating with the third nozzle, and a fourth individual channel communicating with the fourth nozzle. The common channel has a first connection port connected to the first individual channel, a second connection port connected to the second individual channel, a third connection port connected to the third individual channel, and a fourth connection port connected to the fourth individual channel. The driving elements include a first driving element corresponding to the first nozzle, a second driving element corresponding to the second nozzle, a third driving element corresponding to the third nozzle, and a fourth driving element corresponding to the fourth nozzle. A distance between the first connection port and the second connection port is different from a distance between the third connection port and the fourth connection port. The controller is configured to drive the first driving element and the third driving element at a first timing, without driving the second driving element and the fourth driving element, and to drive the second driving element and the fourth driving element at a second timing delayed by a predetermined amount of time from the first timing, without driving the first driving element and the third driving element.

According to a second aspect of the present teaching, a liquid droplet ejecting method to be executed by a controller of a liquid ejecting apparatus is provided. The liquid droplet ejecting apparatus includes: a channel member having an ejection surface in which nozzles are opened, individual channels, and a common channel; driving elements fixed to the channel member; and the controller electrically connected to the driving elements. The nozzles include a first nozzle and a second nozzle which are adjacent to each other along a first direction parallel to the ejection surface, and a third nozzle and a fourth nozzle which are adjacent to each other along a second direction parallel to the ejection surface and crossing the first direction.

The individual channels include a first individual channel communicating with the first nozzle, a second individual channel communicating with the second nozzle, a third individual channel communicating with the third nozzle, and a fourth individual channel communicating with the fourth nozzle. The common channel has a first connection port connected to the first individual channel, a second connection port connected to the second individual channel, a third connection port connected to the third individual channel, and a fourth connection port connected to the fourth individual channel. The driving elements include a first driving element corresponding to the first nozzle, a second driving element corresponding to the second nozzle, a third driving element corresponding to the third nozzle, and a fourth driving element corresponding to the fourth nozzle. A distance between the first connection port and the second connection port is different from a distance between the third connection port and the fourth connection port. The method includes: driving the first driving element and the third driving element at a first timing, without driving the second driving element and the fourth driving element; and driving the second driving element and the fourth driving element at a second timing delayed by a predetermined amount of time from the first timing, without driving the first driving element and the third driving element.

According to the first and second aspects of the present teaching, the occurrence of the periodic unevenness in the result of printing can be reduced, while making the delay time in the driving timing of the driving elements uniform.

### BRIEF DESCRIPTION OF DRAWINGS

FIG. 1 is a plan view of a printer according to a first embodiment of the present teaching.

FIG. 2 is a block diagram depicting the electrical configuration of the printer.

FIG. 3 is a plan view of each of heads constructing a head unit of the printer.

FIG. 4 is a cross-sectional view of the head taken along a IV-IV line in FIG. 3.

FIG. 5 is a diagram depicting the corresponding relationship between nozzles of the head and pixels aligned in a medium-width direction on a medium, and an example of a driving timing of driving elements each of which corresponds to one of the nozzles.

FIG. 6 is a diagram depicting the corresponding relationship between the nozzles of head and the pixels aligned in the medium-width direction on the medium, and another example of the driving timing of the driving elements each of which corresponds to one of the nozzles.

FIG. 7 is a diagram depicting the corresponding relationship between nozzles of a head according to a second embodiment of the present teaching and pixels aligned in a medium-width direction on a medium, and an example of a driving timing of driving elements each of which corresponds to one of the nozzles.

FIG. 8 is a diagram depicting the corresponding relationship between nozzles of a head according to a third embodiment of the present teaching and pixels aligned in the medium- width direction on a medium, and an example of a driving timing of driving elements each of which corresponds to one of the nozzles.

FIG. 9 is a plan view of a printer according to a fourth embodiment of the present teaching.

FIG. 10 depicts the corresponding relationship between the nozzles of the head and the pixels aligned in a conveying direction on the medium, and yet another example of the driving timing of the driving elements each of which corresponds to one of the nozzles, in a case where an ejecting process is performed twice, with a conveying process performed once intervened therebetween.

### DESCRIPTION

### First Embodiment

### (Overall Configuration of Printer 100)

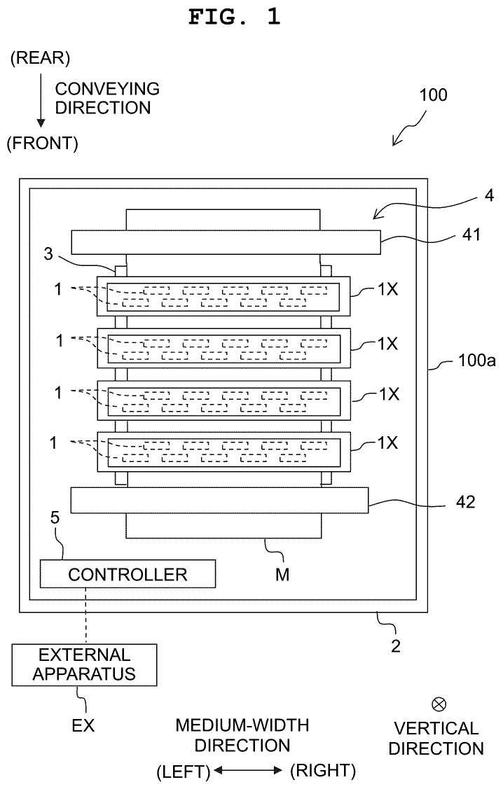

As depicted in FIG. 1, a printer 100 according to a first embodiment of the present teaching includes a casing 100a, four head units 1x, a platen 3, a conveying mechanism 4, and a controller 5. The four head units 1x, the platen 3, the conveying mechanism 4, and the controller 5 are disposed in the casing 100a. The printer 100 further includes an input part which is constructed of a button disposed in the outer surface of the casing 100a.

The four head units 1x are disposed side by side in a conveying direction. The conveying direction is a direction in which a medium M, such as a sheet, etc., is conveyed by the conveying mechanism 4, and is orthogonal to the vertical direction. Each of the four head units 1x is long in a medium-width direction. The medium-width direction is a direction along the width of the medium M, and is orthogonal to the vertical direction and the conveying direction. Each of the four head units 1x is a head unit of the line system which ejects an ink to the medium M in a state that the position of each of the head units 1x is fixed. Each of the four head units 1x includes ten heads 1, as an example. The ten heads 1 are disposed in a staggered manner in the medium-width direction.

The platen 3 is a plate along a plane orthogonal to the vertical direction, and is disposed below the four head units 1x. The medium M is supported on the upper surface of the platen 3.

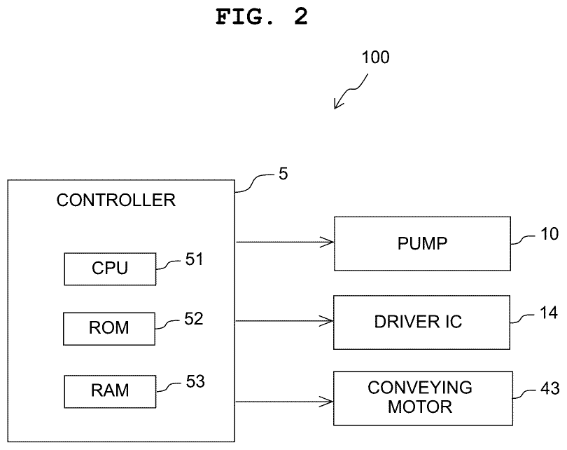

The conveying mechanism 4 includes two roller pairs 41 and 42 and a conveying motor 43 depicted in FIG. 2. In the conveying direction, the four head units 1x and the platen 3 are disposed between the two roller pairs 41 and 42. In a case where the conveying motor 43 is driven by the control of the controller 5, the two roller pairs 41 and 42 rotate. As the two roller pairs 41 and 42 rotate, the medium M nipped and held by the two roller pairs 41 and 42 is thereby conveyed in the conveying direction.

As depicted in FIG. 2, the controller 5 includes a CPU 51, a ROM 52, and a RAM 53.

The CPU 51 executes a variety of kinds of control based on data input from an external apparatus EX depicted in FIG. 1 and/or the input part, and in accordance with a program and/or data stored in the ROM 52 and/or the RAM 53. The external apparatus EX is, for example, a PC.

The ROM 52 stores the programs and/or the data with which the CPU 51 performs the variety of kinds of control. The RAM 53 temporarily stores the data to be used in a case where the CPU 51 executes the programs.

### (Configuration of Head 1)

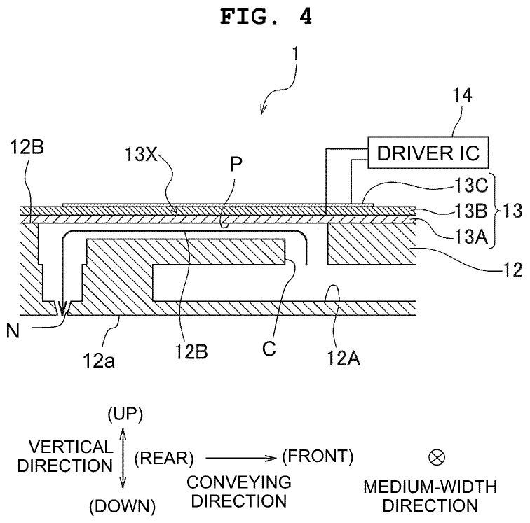

As depicted in FIG. 4, the head 1 includes a channel member 12 and an actuator member 13.

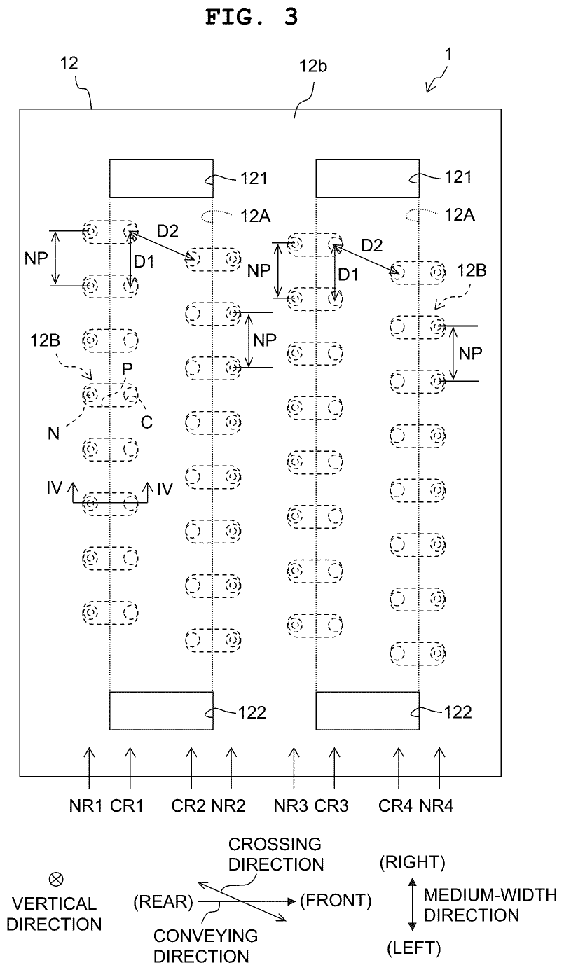

As depicted in FIG. 3, two supply ports 121 and two return ports 122 are open in an upper surface 12b of the channel member 12. The two supply ports 121 and the two return ports 122 each communicate with an ink tank (not depicted in the drawings) via a tube.

The channel member 12 has two common channels 12A and individual channels 12B.

Each of the two common channels 12A extends in the medium-width direction. Each of the two supply ports 121 is connected to one end in the medium-width direction of one of the two common channels 12A, and each of the two return ports 122 is connected to the other end in the medium-width direction of one of the two common channels 12A. The two common channels 12A communicate with the ink tank via the two supply ports 121 and the two return ports 122, and further communicate with the individual channels 12B.

Each of the individual channels 12B is connected to either one of the two common channels 12A. Each of the individual channels 12B includes a nozzle N, a pressure chamber P communicating with the nozzle N, and a connection port C with respect to one of the two common channels 12A.

Nozzles N are open in a lower surface 12a of the channel member 12, and pressure chambers P are open in the upper surface 12b of the channel member 12. In a plane orthogonal to the vertical direction, an opening of each of the nozzles N is substantially circular, and an opening of each of the pressure chambers P is substantially rectangular. Further, in the plane orthogonal to the vertical direction, the connection port C also has a substantially circular shape.

As depicted in FIG. 3, the nozzles N construct four nozzle rows NR1, NR2, NR3 and NR4 disposed side by side in the conveying direction. Each of the nozzle rows NR1 to NR4 is constructed of nozzles N which are aligned in the medium-width direction, at equal spacing distances (each of which is a pitch NP) therebetween.

In the present embodiment, among the nozzle rows NR1 and NR2, the positions of the nozzles N are shifted in the medium-width direction. For example, the positions of the nozzles N constructing the nozzle row NR2 are shifted by half the pitch NP to the left in the medium-width direction, with respect to the positions of the nozzles N constructing the nozzle row NR1. Similarly, among the nozzle rows NR3 and NR4, the positions of the nozzles N are shifted in the medium-width direction. For example, the positions of the nozzles N constructing the nozzle row NR4 are shifted by half the pitch NP to the left in the medium-width direction, with respect to the positions of the nozzles N constructing the nozzle row NR3.

Further, among the nozzle rows NR1 and NR3, the positions of the nozzles N are also shifted in the medium-width direction. For example, the positions of the nozzles N constructing the nozzle row NR3 are shifted by one-quarter of the pitch NP to the left in the medium-width direction, with respect to the positions of the nozzles N constructing the nozzle row NR1. Similarly, among the nozzle rows NR2 and NR4, the positions of the nozzles N are also shifted in the medium-width direction. For example, the positions of the nozzles N constructing the nozzle row NR4 are shifted by one-quarter of the pitch NP to the left in the medium-width direction, with respect to the positions of the nozzles N constructing the nozzle row NR2.

Further, as depicted in FIG. 3, the connection ports C also construct four connection port rows CR1, CR2, CR3 and CR4 which are disposed side by side in the conveying direction. Each of the four connection port rows CR1 to CR4 includes connection ports C aligned at equal spacing distances (each of which is a distance D1) in the medium-width direction. Note that the distance D1 means a distance along a plane parallel to the lower surface 12a of the channel member 12, between the centers of two connection ports C which are adjacent to each other in the medium-width direction. In the present embodiment, distance D1 is, for example, 500 [μm].

Among the connection port rows CR1 and CR2, the positions of the connection ports C are shifted in the medium-width direction. For example, the positions of the connection ports C constructing the connection port row CR2 are shifted by half the distance D1 to the left in the medium-width direction, with respect to the positions of the connection ports C constructing the connection port row CR1. Among connection port rows CR3 and CR4, the positions of the connection ports C are also shifted in the medium-width direction. For example, the positions of the connection ports C constructing the connection port row CR4 are shifted by half the distance D1 to the left in the medium-width direction, with respect to the positions of the connection ports C constructing the connection port row CR3.

Further, among the two connection port rows CR1 and CR3, the positions of the connection ports C are also shifted in the medium-width direction. For example, the positions of the connection ports C constructing the connection port row CR3 are shifted by one-quarter of the distance D1 to the left in the medium-width direction, with respect to the positions of the connection ports C constructing the connection port row CR1. Similarly, among two connection port rows CR2 and CR4, the positions of the connection ports C are also shifted in the medium-width direction. For example, the positions of the connection ports C constructing the connection port row CR4 are shifted by one-quarter of the distance D1 to the left in the medium-width direction, with respect to the positions of the connection ports C constructing the connection port row CR2.

That is, the connection port row CRI is shifted rightward and rearward (to the rear right) with respect to the connection port row CR2, and connection port row CR2 is shifted leftward and frontward (to the front left) with respect to connection port row CR1. Similarly, connection port row CR3 is shifted rightward and rearward (to the rear right) with respect to connection port row CR4, and connection port row CR4 is shifted leftward and frontward (the front left) with respect to connection port row CR3. In the following description, a direction in which connection port rows CR1 and CR2 are shifted from each other is referred to as a “crossing direction”. The crossing direction is a direction which is parallel to the lower surface 12a of the channel member 12 and which crosses the medium-width direction and the conveying direction. The connection port rows CR3 and CR4 are also shifted from each other in the crossing direction, similarly to the connection port rows CR1 and CR2.

Each of the connection ports C constructing the connection port row CR1 and each of the connection ports C constructing the connection port row CR2 are separated by a distance D2 in the crossing direction. Note that in the present embodiment, the distance D2 means a distance along a plane parallel to the lower surface 12a of the channel member 12, between the centers of two connection ports C adjacent to each other in the crossing direction. In the present embodiment, distance D2 is, for example, 800 [μm], which is different from distance D1.

The ink in the ink tank is supplied to the two common channels 12A via, respectively, the two supply ports 121 by driving of a pump 10 depicted in FIG. 2 under the control of the controller 5, and the ink is distributed from the two common channels 12A to the individual channels 12B.

The ink in each of the individual channels 12B is ejected, as an ink droplet, from a nozzle N corresponding thereto by the reduction in the volume of a pressure chamber P corresponding thereto by driving of a piezoelectric element 13X which will be described later.

The ink which moves from one end to the other end in the medium-width direction in each of the two common channels 12A and reaches one of the two return ports 122 is returned to the ink tank via the tube.

As depicted in FIG. 4, the actuator member 13 is fixed to the upper surface 12b of the channel member 12. The actuator member 13 includes a vibration plate 13A made of metal, a piezoelectric layer 13B, and individual electrodes 13C.

The actuator member 13 is constructed by sequentially depositing a thin film which will become the piezoelectric layer 13B and a thin film which will become the individual electrodes 13C on the upper surface of the vibration plate 13A.

The vibration plate 13A is disposed on the upper surface 12b of the channel member 12 so as to cover the pressure chambers P. The piezoelectric layer 13B is disposed on the upper surface of the vibration plate 13A. Each of the individual electrodes 13C is disposed on the upper surface of the piezoelectric layer 13B so as to overlap with one of the pressure chambers P in the vertical direction.

In the vibration plate 13A and the piezoelectric layer 13B, a portion of the vibration plate 13A and a portion of the piezoelectric layer 13B which are sandwiched between one of the individual electrodes 13C and one of the pressure chambers P function as a piezoelectric element 13X. In other words, one piezoelectric element 13X is disposed with respect to each of the pressure chambers P. Further, since each of the pressure chambers P communicates with one nozzle N, one piezoelectric element 13A can be considered as corresponding to each of the nozzles N. Each of the piezoelectric elements 13X can be independently deformed according to a potential applied to one of the individual electrodes 13C.

The vibration plate 13A and the individual electrodes 13C are electrically connected to a driver IC 14. The driver IC 14 maintains the potential of the vibration plate 13A at the ground potential while changing the potential of each of the individual electrodes 13C. The vibration plate 13A functions as a common electrode common to the piezoelectric elements 13X. The driver IC 14 generates a driving signal based on a control signal from the controller 5 and supplies the driving signal to each of the individual electrodes 13C. The driving signal changes the potential of each of the individual electrodes 13C between a predetermined driving potential and the ground potential.

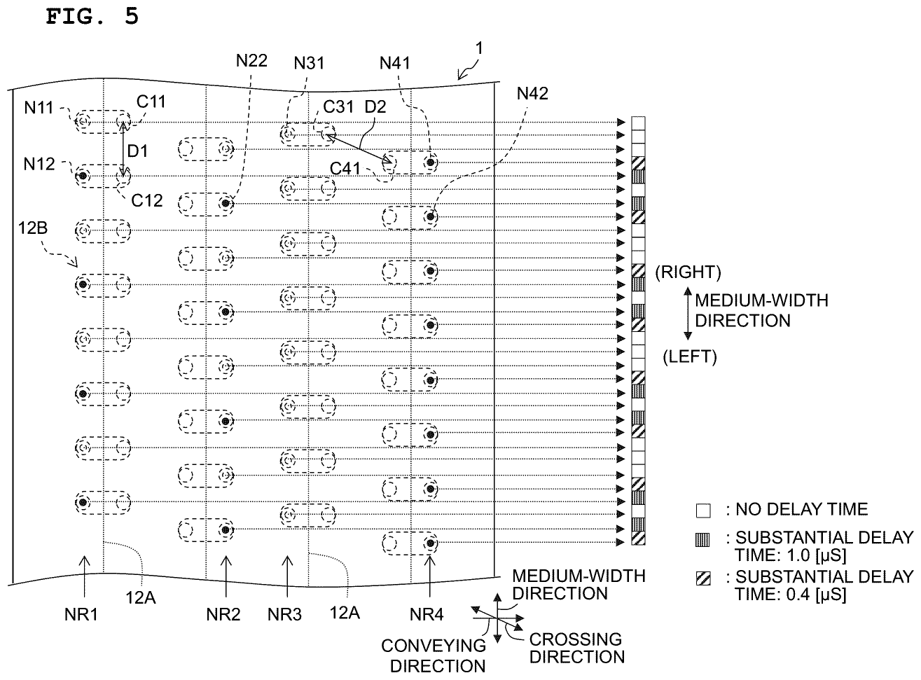

Next, a driving method of the piezoelectric elements 13X by the controller 5 will be described with reference to FIG. 3 and FIG. 5. In the respective ejecting periods (periods in each of which an ink droplet is ejected from each of the nozzles N to form one dot on the medium M), the controller 5 shifts the driving timings of corresponding piezoelectric elements 13X each corresponding to one of the nozzles N by a predetermined amount of time in accordance with a dispose position of each of the nozzles N in the lower surface 12a of the channel member 12.

Specifically, in each of the ejecting periods, the controller 5 drives piezoelectric elements 13X included in the driving elements 13X and corresponding to non-black painted nozzles N included in the nozzles N in FIG. 5 at a first timing. The non-black painted nozzles N are, in other words, odd-numbered nozzles N from the right in the medium-width direction of the nozzle row NR1, odd-numbered nozzles N from the right in the medium-width direction of the nozzle row NR2, and all the nozzles N constructing the nozzle row NR3. On the other hand, in each of the ejecting periods, the controller 5 drives piezoelectric elements 13X included in the driving elements 13X and corresponding to black-painted nozzles N in FIG. 5 at a second timing which is delayed from the first timing by the predetermined amount of time. The black-painted nozzles N are, in other words, even-numbered nozzles N from the right in the medium-width direction of the nozzle row NR1, even-numbered nozzles N from the right in the medium-width direction of the nozzle row NR2, and all the nozzles N constructing the nozzle row NR4. In the present embodiment, the delay time is uniform (one type) which is, for example, 2.0 μs. In the following, the piezoelectric elements 13X driven at the first timing are also referred to as precedingly-driven piezoelectric elements 13X, and the piezoelectric elements 13X driven at the second timing are also referred to as subsequently-driven piezoelectric elements 13X.

At the first timing, the controller 5 drives the precedingly-driven piezoelectric elements 13X, without driving the subsequently-driven piezoelectric elements 13X; at the second timing, the controller 5 drives the subsequently-driven piezoelectric elements 13X, without driving the precedingly-driven piezoelectric elements 13X. Note that in order to shift the driving timing of the precedingly-driven piezoelectric elements 13X with respect to the driving timing of the subsequently-driven piezoelectric elements 13X, for example, in one discharge period, the driving waveform of the driving signal supplied to the precedingly-driven piezoelectric elements 13X and the driving waveform of the driving signal supplied to the subsequently-driven piezoelectric elements 13X may be changed. Specifically, the timing for changing the potential of each of the individual electrodes 13C may be changed between the driving waveform of the precedingly-driven piezoelectric elements 13X and the driving waveform of the subsequently-driven piezoelectric elements 13X.

Next, the influence of crosstalk between the two nozzles N adjacent to each other in the medium-width direction will be described, with a nozzle N11 and a nozzle N12 depicted in FIG. 5 as an example. First, the controller 5 drives a piezoelectric element 13X corresponding to the nozzle N11 at the first timing. Here, as described above, the distance D1 between two connection ports C11 and C12 adjacent to each other in the medium-width direction is 500 [μm]. Therefore, in a case where the velocity of the pressure wave in the ink is 500 [m/s], a time required for the pressure wave generated by driving of the piezoelectric element 13X corresponding to the nozzle N11 to reach the connection port C12 from the connection port C11 is 1.0 [μs] (=500 [μm]/500 [m/s]). Then, the controller 5 drives a piezoelectric element 13X corresponding to the nozzle N12 at the second timing delayed by 2.0 [μs] from the first timing. That is, the controller 5 drives the subsequently-driven piezoelectric element 13X, after 1.0 [μs] (=2.0 [μs]-1.0 [μs]) since the pressure wave caused by driving the precedingly-driven piezoelectric elements 13X has reached the connection port C12. Accordingly, the influence of crosstalk corresponding to a substantial delay time 1.0 [μs] obtained by subtracting the arrival time 1.0 [μs] of the pressure wave from the actual delay time 2.0 [μs] occurs in the nozzle N12.

Next, the influence of crosstalk between two nozzles N adjacent to each other in the crossing direction will be described, with a nozzle N31 and a nozzle N41 depicted in FIG. 5 as an example. First, the controller 5 drives a piezoelectric element 13X corresponding to the nozzle N31 at the first timing. Here, as described above, the distance D2 between two connection ports C31 and C41 adjacent to each other in the crossing direction is 800 [μm]. Therefore, in a case where the velocity of the pressure wave in the ink is 500 [m/s], a time required for the pressure wave generated by driving of the piezoelectric element 13X corresponding to the nozzle N31 to reach the connection port C41 from the connection port C31 is 1.6 [μs] (=800 [μm]/500 [m/s]). Then, the controller 5 drives a piezoelectric element 13X corresponding to the nozzle N41 at the second timing delayed by 2.0 [μs] from the first timing. That is, the controller 5 drives the subsequently-driven piezoelectric element 13X after 0.4 [μs] (=2.0 [μs]-1.6 [μs]) since the pressure wave caused by driving the precedingly-driven piezoelectric elements 13X has reached the connection port C41. Accordingly, the influence of crosstalk corresponding to a substantial delay time of 0.4 [μs] obtained by subtracting the arrival time of the pressure wave of 1.6 [μs] from the actual delay time of 2.0 [μs] occurs in the nozzle N41.

In this way, in the present embodiment, the actual delay time is uniform (one type) between the two nozzles N adjacent to each other in the medium-width direction and the two nozzles N adjacent to each other in the crossing direction, while the substantial delay time can be made different. As a result, the influence of crosstalk, i.e., the ejecting velocity of the ink droplet, the volume of the ink droplet, the separation state of the ink droplet, and the like, can be made different between the two nozzles N adjacent to each other in the medium-width direction and the two nozzles N adjacent to each other in the crossing direction. Further, as depicted in FIG. 5, the nozzles N are disposed so that the positions thereof in the medium-width direction are mutually different, and each of the nozzles corresponds to one of the pixels aligned in the medium-width direction on the medium M. Accordingly, pixels corresponding to the nozzles N with the same substantial delay time (i.e., nozzles N affected by the same level of the crosstalk) can be prevented from being continuous in the medium-width direction. In other words, the pixels, on which the ink droplets ejected from the nozzles N affected by the same level of the crosstalk land, can be dispersed in the medium-width direction. As a result, the occurrence of periodic unevenness in the result of printing can be reduced.

In the above-described embodiments, the lower surface 12a of the channel member 12 is an example of an “ejection surface”. The medium-width direction is an example of a “first direction”, the crossing direction is an example of a “second direction”, and the conveying direction is an example of a “third direction”. The nozzle N11 is an example of a “first nozzle”, the nozzle N12 is an example of a “second nozzle”, the nozzle N31 is an example of a “third nozzle”, and the nozzle N41 is an example of a “fourth nozzle”. The individual channel 12B communicating with the nozzle N11 is an example of a “first individual channel”, the individual channel 12B communicating with the nozzle N12 is an example of a “second individual channel”, the individual channel 12B communicating with the nozzle N31 is an example of a “third individual channel”, and the individual channel 12B communicating with the nozzle N41 is an example of a “fourth individual channel”. The connection port C11 is an example of a “first connection port”, the connection port C12 is an example of a “second connection port”, the connection port C31 is an example of a “third connection port”, and the connection port C41 is an example of a “fourth connection port”. Further, the piezoelectric element 13X corresponding to the nozzle N11 is an example of a “first driving element”, the piezoelectric element 13X corresponding to the nozzle N12 is an example of a “second driving element”, the piezoelectric element 13X corresponding to the nozzle N31 is an example of a “third driving element”, and the piezoelectric element 13X corresponding to the nozzle N41 is an example of a “fourth driving element”. The actual delay time is an example of a “predetermined amount of time”.

Furthermore, the nozzle row NR1 is an example of a “first nozzle row”, the nozzle row NR2 is an example of a “second nozzle row”, the nozzle row NR3 is an example of a “third nozzle row”, and the nozzle row NR4 is an example of a “fourth nozzle row”. The nozzle row NR1 and the nozzle row NR2 are an example of a “first nozzle row group”, and the nozzle row NR3 and the nozzle row NR4 are an example of a “second nozzle row group”.

In the above-described embodiment, in each of the ejecting periods, the piezoelectric elements 13X corresponding to the non-black painted nozzles N in FIG. 5 are driven at the first timing, and the piezoelectric elements 13X corresponding to the black-painted nozzles N in FIG. 5 are driven at the second timing. However, the driving timing of the piezoelectric elements 13X is not limited to this.

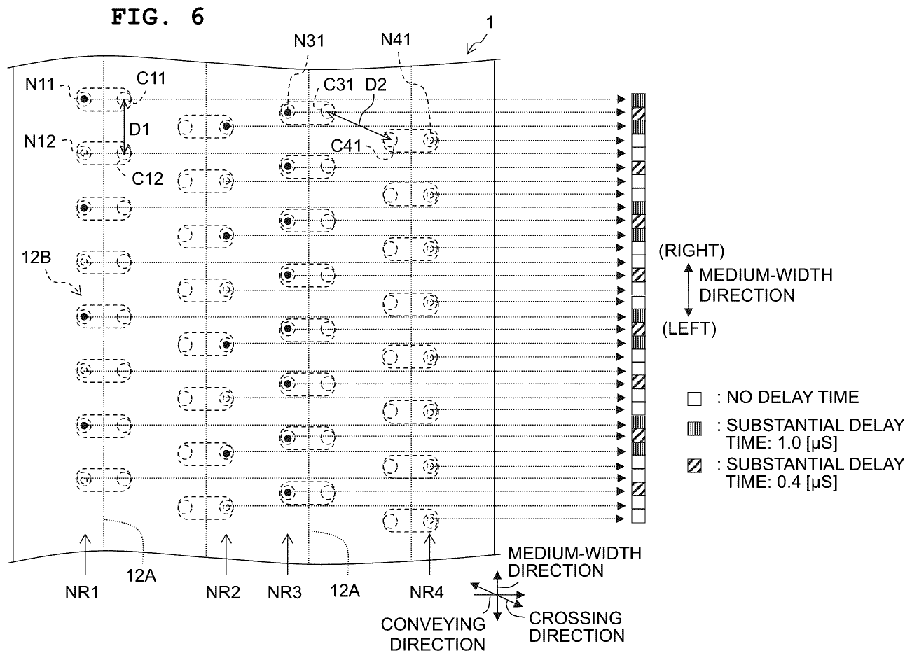

For example, in FIG. 6, piezoelectric elements 13X each corresponding to one of non-black painted nozzles N may be driven at the first timing, and piezoelectric elements 13X each corresponding to one of black-painted nozzles N may be driven at the second timing. The non-black painted nozzles N are, in other words, even-numbered nozzles N from the right in the medium-width direction of the nozzle row NR1, even-numbered nozzles N from the right in the medium-width direction of the nozzle row NR2, and all the nozzles N constructing the nozzle row NR4. The black-painted nozzles N are, in other words, odd-numbered nozzles N from the right in the medium-width direction of the nozzle row NR1, odd-numbered nozzles N from the right in the medium-width direction of the nozzle row NR2, and all the nozzles N constructing nozzle row NR3.

Alternatively, the piezoelectric elements 13X corresponding to the odd-numbered nozzles N from the right in the medium-width direction of the nozzle row NR1, the odd-numbered nozzles N from the right in the medium-width direction of the nozzle row NR2, and all the nozzles N constructing the nozzle row NR4 may be driven at the first timing, and the piezoelectric elements 13X corresponding to the even-numbered nozzles N from the right in the medium-width direction of the nozzle row NR1, the even-numbered nozzles N from the right in the medium-width direction of the nozzle row NR2, and all the nozzles N constructing the nozzle row NR3 may be driven at the second timing.

Still alternatively, the piezoelectric elements 13X corresponding to the even-numbered nozzles N from the right in the medium-width direction of the nozzle row NR1, the even-numbered nozzles N from the right in the medium-width direction of the nozzle row NR2, and all the nozzles N constructing the nozzle row NR3 may be driven at the first timing, and the piezoelectric elements 13X corresponding to the odd-numbered nozzles N from the right in the medium-width direction of the nozzle row NR1, the odd-numbered nozzles N from the right in the medium-width direction of the nozzle row NR2, and all the nozzles N constructing the nozzle row NR4 may be driven at the second timing.

In either one of the above-described cases, pixels corresponding to the nozzles N with the same substantial delay time (i.e., nozzles N affected by the same level of the crosstalk) can be prevented from being continuous in the medium-width direction. In other words, the pixels, on which the ink droplets ejected from the nozzles N affected by the same level of the crosstalk land, can be dispersed in the medium-width direction. As a result, the occurrence of the periodic unevenness in the result of printing can be prevented.

Further, for example, the head 1 as depicted in FIG. 5 (hereinafter referred to as a “first head 1”) and the head 1 as depicted in FIG. 6 (hereinafter referred to as a “second head 2”) may be prepared, and the first head 1 and the second head 2 may be disposed in the conveying direction. Specifically, the first head 1 and the second head 2 may be disposed in the conveying direction such that the positions in the medium-width direction of the nozzles N included in the first head 1 and the positions in the medium-width direction of the nozzles N included in the second head 2 match one another. That is, in the medium-width direction, the position of the nozzle row NR1 of the first head 1 matches the position of the nozzle row NR1 of the second head 2, the position of the nozzle row NR2 of the first head 1 matches the position of the nozzle row NR2 of the second head 2, the position of the nozzle row NR3 of the first head 1 matches the position of the nozzle row NR3 of the second head 2, and the position of the nozzle row NR4 of the first head 1 matches the position of the nozzle row NR4 of the second head 2. In this case, one nozzle N of the nozzles N included in the first head 1 and one nozzle N of the nozzles N included in the second head 2 correspond to each of the pixels aligned in the medium-width direction. Then, an ink of a first color may be supplied to the first head 1, and an ink of a second color different from the first color may be supplied to the second head 2. Further, in the first head 1, the driving timing of the piezoelectric elements 13X each corresponding to one of the black-painted nozzles N in FIG. 5 may be delayed, and in the second head 2, the driving timing of the piezoelectric elements 13X each corresponding to one of the black-painted nozzles N in FIG. 6 may be delayed. In this case, as can be appreciated by comparing FIG. 5 and FIG. 6, the influence of crosstalk is different between the nozzles N each corresponding to one of the pixels of the first head 1 and the nozzles N each corresponding to one of the pixels of the second head 2. For example, as depicted in FIG. 5, the nozzle N11 of the first head 1 corresponds to a first pixel from the right in the medium-width direction, and the nozzle N11 of the first head 1 has no delay time and is not affected by the influence of crosstalk. In contrast, as depicted in FIG. 6, the nozzle N11 of the second head 2 also corresponds to the first pixel from the right in the medium-width direction, and the substantial delay time of the nozzle N11 of the second head 2 is 1.0 [μs]. In other words, the nozzle N11 of the second head 2 is influenced by the crosstalk (e.g., the reduction in the volume of ink droplet, etc.) corresponding to the substantial delay time of 1.0 [μs]. Accordingly, the occurrence of such a situation can be prevented that ink droplets, respectively, of the two colors each ejected from one of two nozzles N influenced by the crosstalk to the same extent land on the same pixel and allowing the influence of crosstalk to be overlaid in this pixel and making the pixel conspicuous.

Further, in the above-described embodiment, although the nozzle row NR3 and the nozzle row NR4 are shifted by one-quarter of the pitch NP to the left in the medium-width direction, respectively, with respect to the nozzle row NR1 and the nozzle row NR2, the present teaching is not limited to this. For example, in FIG. 5, the positions in the medium-width direction of the nozzles N constructing the nozzle row NR3 may each match one of the positions in the medium-width direction of the nozzles N constructing the nozzle row NR1, and the positions in the medium-width direction of the nozzles N constructing the nozzle row NR4 may each match one of the positions in the medium-width direction of the nozzles N constructing the nozzle row NR2. In this case, one nozzle N among the nozzles N constructing the nozzle rows NR1 and NR2 and one nozzle N among the nozzles N constructing the nozzle rows NR3 and NR4 correspond to each of the pixels aligned in the medium-width direction. Furthermore, the ink of the first color may be supplied to one of the two common channels 12A with which the nozzles N constructing the nozzle rows NR1 and NR2 communicate, and the ink of the second color, which is different from the first color, may be supplied to the other of the two common channels 12A with which the nozzles N constructing the nozzle rows NR3 and NR4 communicate. Moreover, the driving timing of each of the piezoelectric elements 13X corresponding to one of the black-painted nozzles N in FIG. 5 may be delayed. In this case also, the influence of crosstalk differs between one nozzle N and the other nozzle N corresponding to each of the pixels. For example, in FIG. 5, the nozzle N22 and the nozzle N42 correspond to the same pixel. Further, the nozzle N22 is influenced by the crosstalk corresponding to the substantial delay time of 1.0 [μs], whereas the nozzle N42 is influenced by the crosstalk corresponding to the substantial delay time of 0.4 [μs]. Accordingly, the occurrence of such a situation can be prevented that ink droplets, respectively, of the two colors each ejected from one of two nozzles N influenced by the crosstalk to the same extent land on the same pixel and allowing the influence of crosstalk to be overlaid in this pixel and making the pixel conspicuous.

### Second Embodiment

Next, a second embodiment of the present teaching will be described. A head 1 of the second embodiment is different from the head 1 of the first embodiment in the numbers and located positions of the common channels 12A, the individual channels 12B, and the piezoelectric elements 13X. The following description will focus on the difference from the head 1 of the first embodiment.

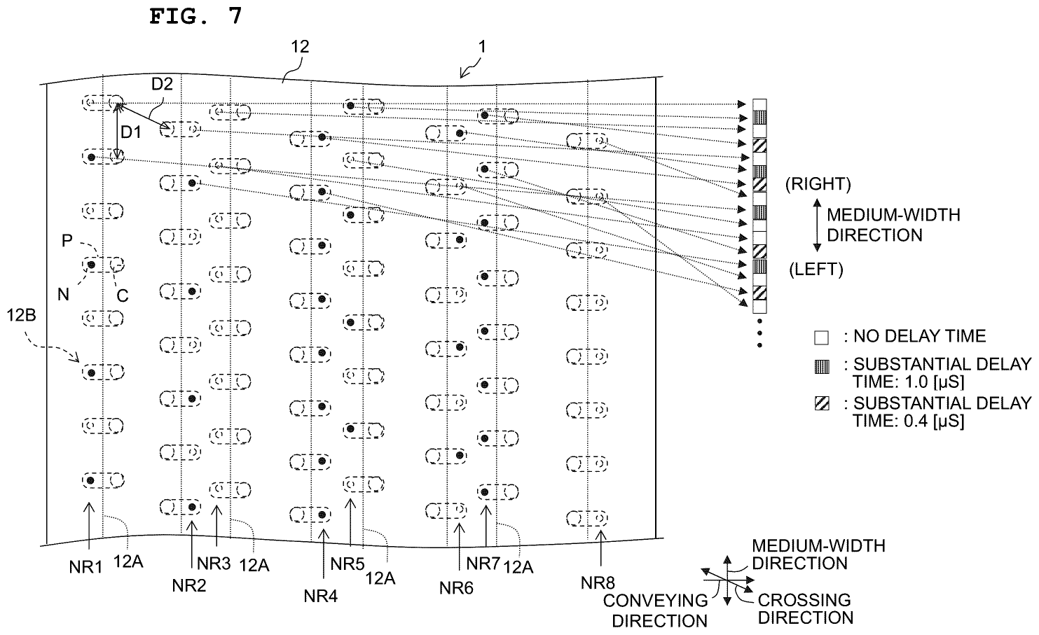

As depicted in FIG. 7, the channel member 12 has four common channels 12A and individual channels 12B.

Each of the individual channels 12B is connected to one of the four common channels 12A. Each of the individual channels 12B includes a nozzle N, a pressure chamber P communicating with the nozzle N, and a connection port C with respect to one of the four common channels 12A.

Nozzles N each of which belongs to one of the individual channels 12B construct eight nozzle rows NR1 to NR8 disposed side by side in the conveying direction. Each of the eight nozzle rows NR1 to NR8 is constructed of nozzles N aligned at equal spacing distances (each of which is a pitch NP) therebetween in the medium-width direction.

In the second embodiment, in the nozzle rows NR1 to NR8, the positions of the nozzles N in the medium-width direction are different. For example, nozzles N constructing the nozzle row NR2 are shifted by half the pitch NP to the left in the medium-width direction with respect to nozzles N constructing the nozzle row NR1, and nozzles N constructing the nozzle row NR4 are shifted by half the pitch NP to the left in the medium-width direction with respect to nozzles N constructing the nozzle row NR3.

Further, the nozzles N constructing nozzle row NR3 are shifted by one-quarter of the pitch NP to the left in the medium-width direction with respect to the nozzles N constructing nozzle row NR1, and the nozzles N constructing nozzle row NR4 are shifted by one-quarter of the pitch NP to the left in the medium-width direction with respect to the nozzles N constructing nozzle row NR2.

Furthermore, the nozzles N constructing each of the nozzle rows NR5 to NR8 are shifted by one-eighth of the pitch NP to the left in the medium-width direction with respect to the nozzles N constructing one of the nozzle rows NR1 to NR4.

Moreover, in the second embodiment, in each of the ejecting periods, the controller 5 drives piezoelectric elements 13X each corresponding to one of non-black painted nozzles N in FIG. 7 at the first timing. The non-black painted nozzles N are, in other words, odd-numbered nozzles N from the right in the medium-width direction of each of the nozzle rows NR1 and NR2, even-numbered nozzles N from the right in the medium-width direction of each of the nozzle rows NR5 and NR6, and all the nozzles N constructing each of the nozzle rows NR3 and NR8. On the other hand, the controller 8 drives piezoelectric elements 13X each corresponding to one of black-painted nozzles N in FIG. 7 at the second timing which is delayed by a predetermined amount of time from the first timing. The black-painted nozzles N are: even-numbered nozzles N from the right in the medium-width direction of each of the nozzle row NR1 and the nozzle row NR2, odd-numbered nozzles N from the right in the medium-width direction of each of the nozzle rows NR5 and the nozzle rows NR6, and all the nozzles constructing the nozzle row NR4 and the nozzle row NR7.

Further, by driving each of the piezoelectric elements 13X at the above-described timing, as depicted in FIG. 7, pixels corresponding to the nozzles N with the same substantial delay time (i.e., nozzles N affected by the same level of the crosstalk) can be prevented from being continuous in the medium-width direction. In other words, the pixels, on which the ink droplets ejected from the nozzles N affected by the same level of the crosstalk land, can be dispersed in the medium-width direction. As a result, the occurrence of the periodic unevenness in the result of printing can be prevented. Namely, an effect similar to the effect obtained in the first embodiment can be obtained.

In the second embodiment, the nozzle row NR5 is an example of a “fifth nozzle row”, the nozzle row NR6 is an example of a “sixth nozzle row”, the nozzle row NR7 is an example of a “seventh nozzle row”, and the nozzle row NR8 is an example of an “eighth nozzle row”. The nozzle row NR5 and the nozzle row NR6 are an example of a “third nozzle row group”, and the nozzle row NR7 and the nozzle row NR8 are an example of a “fourth nozzle row group”.

In the second embodiment, the nozzle rows NR5 and NR6 may be omitted, and the nozzle rows NR7 and NR8 may be omitted, in the channel member 12 of the head 1. In other words, the channel member 12 of the head 1 may include the nozzle rows NR1 to NR4 and the nozzle rows NR7 and NR8; or the channel member 12 of the head 1 may include the nozzle rows NR1 to NR6.

Further, the piezoelectric elements 13X driven at the first timing in the second embodiment may be driven at the second timing, and the piezoelectric elements 13X driven at the second timing in the second embodiment may be driven at the first timing. In other words, the order of driving the piezoelectric elements 13X in the second embodiment may be reversed.

### Third Embodiment

Next, a third embodiment of the present teaching will be described. A head 1 of the third embodiment is also different from the head 1 of the first embodiment in the numbers and located positions of the common channel 12A, the individual channel 12B, and the piezoelectric element 13X. The following description will focus on the difference from the head 1 of the first embodiment.

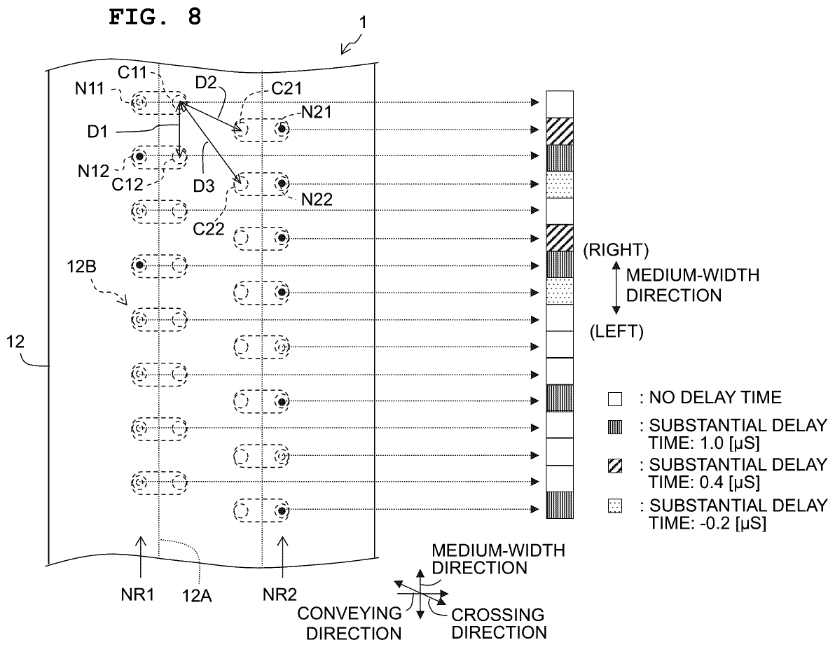

As depicted in FIG. 8, the channel member 12 of the head 1 has one common channel 12A and individual channels 12B. Each of the individual channels 12B is connected to the common channel 12A. Each of the individual channels 12B includes a nozzle N, a pressure chamber P communicating with the nozzle N, and a connection port C with respect to the common channel 12A.

The nozzles N construct two nozzle rows NR1 and NR2 disposed side by side in the conveying direction. Each of the nozzle rows NR1 and NR2 is constructed of nozzles N aligned at equal spacing distances (each of which is a pitch NP) in the medium-width direction. The nozzles N which construct the nozzle row NR2 are shifted to the left in the medium-width direction by half the pitch NP with respect to the nozzles N which construct the nozzle row NR1. Note that in FIG. 8, a distance D3 between a connection port C11 and a connection port C22 is longer than the distance D1 and the distance D2, and the distance D3 is, for example, 1100 [μm].

In the third embodiment, in each of the ejecting periods, the controller 5 drives piezoelectric elements 13X each corresponding to one of non-black painted nozzles N in FIG. 8 at the first timing. The non-black painted nozzles N are, in other words, the first, third and fifth to eighth nozzles N from the right in the medium-width direction of the nozzle row NR1, and the fifth and seventh nozzles N from the right in the medium-width direction of the nozzle row NR2. On the other hand, the controller 5 drives piezoelectric elements 13X each corresponding to one of black-painted nozzles N in FIG. 8 at the second timing, delayed by a predetermined amount of time from the first timing. The black-painted nozzles N are, in other words, the second and fourth nozzles N from the right in the medium-width direction of the nozzle row NR1, and the first to fourth, sixth and eighth nozzles N from the right in the medium-width direction of the nozzle row NR2.

Here, the influence of crosstalk in two nozzles N in a positional relationship such as the nozzle N11 and the nozzle N22 depicted in FIG. 8 will be described, with the nozzle N11 and the nozzle N22 as an example. First, the controller 5 drives a piezoelectric element 13X, included in the piezoelectric elements 13X and corresponding to the nozzle N11, at the first timing. Here, as described above, the distance D3 between the two connection ports C11 and C22 is 1100 [μm]. Accordingly, in a case where the velocity of the pressure wave in the ink is 500 [m/s], the time required for a pressure wave generated by driving of the piezoelectric element 13X corresponding to the nozzle N11 to reach the connection port C22 from the connection port C11 is 2.2 [μs] (=1100 [μm] /500 [m/s]). Then, the controller 5 drives a piezoelectric element 13X corresponding to the nozzle N41 at the second timing delayed by 2.0 [μs] from the first timing. That is, the controller 5 drives the subsequently-driven piezoelectric elements 13X, 0.2 [μs](=2.2 [μs]−2.0 [μs]) before the pressure wave generated by the driving of the precedently-driven piezoelectric elements 13X reaches the connection port C41. Accordingly, the influence of crosstalk corresponding to a substantial delay time −0.2 [μs] obtained by subtracting the arrival time of the pressure wave 2.2 [μs] from the actual delay time 2.0 [μs] occurs in the nozzle N22.

Further, by driving each of the piezoelectric elements 13X at the above-described timing, as depicted in FIG. 8, pixels corresponding to the nozzles N with the same substantial delay time (i.e., nozzles N affected by the same level of the crosstalk) can be prevented from being continuous in the medium-width direction. In other words, the pixels, on which the ink droplets ejected from the nozzles N affected by the same level of the crosstalk land, can be dispersed in the medium-width direction. As a result, the occurrence of the periodic unevenness in the result of printing can be prevented. Namely, an effect similar to the effect obtained in the first embodiment can be obtained.

In the third embodiment, the nozzle N11 is an example of the “first nozzle” and the “third nozzle”, the nozzle N12 is an example of the “second nozzle”, and the nozzle N21 is an example of the “fourth nozzle”.

### Fourth Embodiment

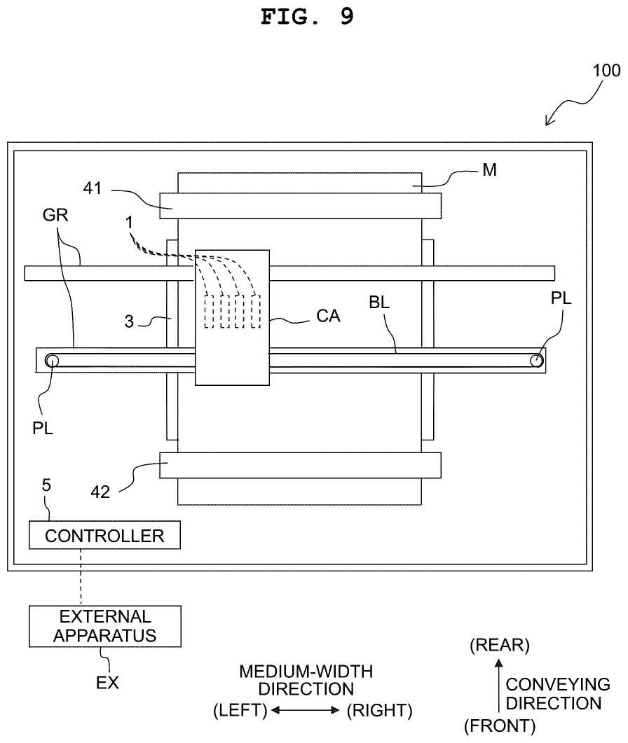

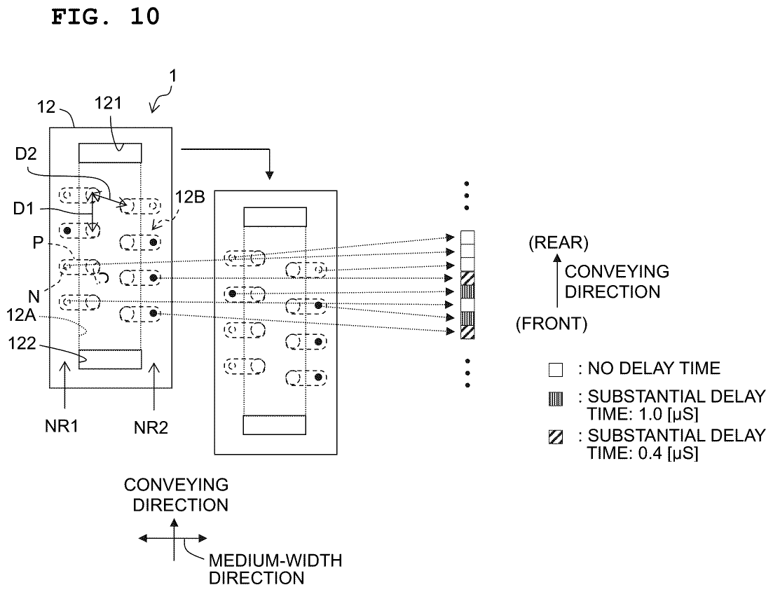

Next, a fourth embodiment of the present teaching will be described. A printer 100 of the fourth embodiment is a printer of the serial system including a carriage CA on which a plurality of heads 1 are mounted, as depicted in FIG. 9. The printer 100 further includes two guide rails GR extending in parallel to each other along the medium-width direction, two pulleys PL disposed in one of the two guide rails GR, and an endless belt BL which is wound around the two pulleys PL and connected to the carriage CA. The non-illustrated motor is driven by the controller 5 so as to rotate the two pulleys PL. With this, the endless belt BL runs along the medium-width direction, and the carriage CA reciprocates in the medium-width direction, accompanying the running of the endless belt BL. In this configuration, the heads 1 are disposed side by side in the medium-width direction. Further, as depicted in FIG. 10, each of the heads 1 has nozzles N aligned in the conveying direction. Printing is performed on the medium M by alternately repeating a conveying process in which the medium M is conveyed by a predetermined distance in the conveying direction and an ejecting process in which an ink droplet is ejected from each of the nozzles N of one of the heads 1 while moving the carriage CA along the medium-width direction.

As depicted in FIG. 10, the channel member 12 of the head 1 has one common channel 12A and individual channels 12B. Each of the individual channels 12B is connected to the common channel 12A. Each of the individual channels 12B includes a nozzle N, a pressure chamber P communicating with the nozzle N, and a connection port C with respect to the common channel 12A.

Nozzles N each of which belongs to one of the individual channels 12B construct two nozzle rows NR1 and NR2 disposed side by side in the medium-width direction. Each of the nozzle rows NR1 and NR2 is constructed of nozzles N, included in the nozzles N and aligned at equal spacing distances (each of which is a pitch NP) in the conveying direction. The nozzles N which construct the nozzle row NR2 are shifted to the front in the conveying direction by half the pitch NP with respect to the nozzles N which construct the nozzle row NR1.

In the fourth embodiment, in each of the ejecting periods, the controller 5 drives piezoelectric elements 13X each corresponding to one of non-black painted nozzles N in FIG. 10 at the first timing. The non-black painted nozzles N are, in other words, the first, third and fourth nozzles N from the rear in the conveying direction of the nozzle row NR1, and the first nozzle N from the rear in the conveying direction of the nozzle row NR2. On the other hand, the controller 5 drives piezoelectric elements 13X each corresponding to one of black-painted nozzles N in FIG. 10 at the second timing which is delayed by a predetermined amount of time from the first timing. The black-painted nozzles N are, in other words, the second nozzle N from the rear in the conveying direction of the nozzle row NR1, and the second, third and fourth nozzles N from the rear in the conveying direction of the nozzle row NR2. Note that FIG. 10 depicts the corresponding relationship between the nozzles N and pixels aligned in the conveying direction on the medium M, in a case where the ejecting process has been performed twice, with the conveying process performed once intervened therebetween.

By driving each of the piezoelectric elements 13X with the above-described timing, pixels corresponding to the nozzles N with the same substantial delay time (i.e., nozzles N affected by the same level of the crosstalk) can be prevented from being continuous in the conveying direction. In other words, the pixels, on which the ink droplets ejected from the nozzles N affected by the same level of the crosstalk land, can be dispersed in the conveying direction. As a result, the occurrence of periodic unevenness in the result of printing can be reduced. In other words, an effect similar to the effect obtained in the first embodiment can be obtained.

In the fourth embodiment, the first to third nozzles N from the rear in the conveying direction of the nozzle row NR1 are an example of the “first nozzle”, the “second nozzle” and the “third nozzle”, respectively; and the third nozzle N from the rear in the conveying direction of the nozzle row NR2 is an example of the “fourth nozzle”. Further, the conveying direction is an example of the “first direction”, and the medium-width direction is an example of the “third direction”.

In the foregoing, although the embodiments and modifications of the present teaching have been described, the present teaching is not limited to the above-described embodiments and modifications, and various design changes are possible within the scope of the claims.

In the above-described embodiments and modifications, the controller 5 may change the order of the piezoelectric elements 13X driven at the first timing and the piezoelectric elements 13X driven at the second timing, and may change the actual delay time, based on a predetermined condition. Here, the predetermined condition includes, for example, the printing velocity, the printing resolution, the printing density, the temperature in the use environment of the printer, the back pressure of the ink supplying system, the kind and/or lot of the ink(s), etc. Further, the controller 5 may obtain these conditions as values input from the external apparatus EX or the input part of the printer 100, or may obtain these conditions from various kinds of sensors, etc., included in the printer 100.

In the above-described embodiments and modifications, although the electrodes constructing the piezoelectric element are in a two-layered configuration including the individual electrodes and the common electrode, the electrodes constructing the piezoelectric element may be in a three-layered configuration. For example, the three-layered configuration is a configuration including a driving electrode to which a high potential and a low potential are selectively applied, a high potential electrode which is held at the high potential, and a low potential electrode which is held at the low potential.

The medium M is not limited to a sheet. For example, the medium M may be cloth, a substrate, or plastic.

The liquid droplets ejected from the nozzles N are not limited to the ink droplets. For example, the liquid droplets may be liquid droplets of a treatment liquid which causes a component in an ink to aggregate or precipitate.

The present teaching is not limited to being applicable to the printer, but is also applicable to a facsimile, a copying apparatus, and a multi-function peripheral. Further, the present teaching is also applicable to a liquid droplet ejecting apparatus for usage other than image recording. For example, the present teaching is also applicable to a liquid droplet ejecting apparatus which ejects a conductive liquid to a substrate so as to form a conductive pattern.

What is claimed is:

1. A liquid droplet ejecting apparatus comprising:
a channel member having an ejection surface in which nozzles are opened, individual channels, and a common channel;
driving elements fixed to the channel member; and
a controller electrically connected to the driving elements,
wherein
the nozzles include a first nozzle and a second nozzle which are adjacent to each other along a first direction parallel to the ejection surface, and a third nozzle and a fourth nozzle which are adjacent to each other along a second direction parallel to the ejection surface and crossing the first direction,
the individual channels include a first individual channel communicating with the first nozzle, a second individual channel communicating with the second nozzle, a third individual channel communicating with the third nozzle, and a fourth individual channel communicating with the fourth nozzle,
the common channel has a first connection port connected to the first individual channel, a second connection port connected to the second individual channel, a third connection port connected to the third individual channel, and a fourth connection port connected to the fourth individual channel,
the driving elements include a first driving element corresponding to the first nozzle, a second driving element corresponding to the second nozzle, a third driving element corresponding to the third nozzle, and a fourth driving element corresponding to the fourth nozzle,
a distance between the first connection port and the second connection port is different from a distance between the third connection port and the fourth connection port, and
the controller is configured to drive the first driving element and the third driving element at a first timing, without driving the second driving element and the fourth driving element, and to drive the second driving element and the fourth driving element at a second timing delayed by a predetermined amount of time from the first timing, without driving the first driving element and the third driving element.

2. The liquid droplet ejecting apparatus according to claim 1, wherein
the nozzles include a first nozzle row group and a second nozzle row group which are disposed side by side in a third direction which is parallel to the ejection surface and orthogonal to the first direction,
the first nozzle row group includes a first nozzle row and a second nozzle row each of which is formed along the first direction and which are adjacent to each other in the third direction,
the second nozzle row group includes a third nozzle row and a fourth nozzle row each of which is formed along the first direction and which are adjacent to each other in the third direction,
the first nozzle row includes the first nozzle as first nozzles and the second nozzle as second nozzles,
in the first nozzle row, the first nozzles and the second nozzles are alternately positioned at a predetermined spacing distance along the first direction,
the second nozzle row includes the first nozzle as the first nozzles and the second nozzle as the second nozzles,
in the second nozzle row, the first nozzles and the second nozzles are alternately positioned at the predetermined spacing distance along the first direction,
the third nozzle row includes the third nozzle as third nozzles which are positioned at the predetermined spacing distance along the first direction,
the fourth nozzle row includes the fourth nozzle as fourth nozzles which are positioned at the predetermined spacing distance along the first direction, and
the first nozzles and the second nozzles included in the first nozzle row, the first nozzles and the second nozzles included in the second nozzle row, the third nozzles included in the third nozzle row, and the fourth nozzles included in the fourth nozzle row are mutually different in positions in the first direction.

3. The liquid droplet ejecting apparatus according to claim 1, wherein
the controller is configured to drive the driving elements to eject liquid droplets from the nozzles to a medium, and
in the medium, a pixel corresponding to the second nozzle and a pixel corresponding to the fourth nozzle are adjacent to each other in the first direction.

4. The liquid droplet ejecting apparatus according to claim 2, wherein
the nozzles further include at least one of a third nozzle row group or a fourth nozzle row group disposed side by side with the first nozzle row group and the second nozzle row group in the third direction,
the third nozzle row group includes a fifth nozzle row and a sixth nozzle row each of which is formed along the first direction and which are adjacent to each other in the third direction,
the fifth nozzle row includes the first nozzle as the first nozzles and the second nozzle as the second nozzles,
in the fifth nozzle row, the first nozzles and the second nozzles are alternately positioned at the predetermined spacing distance along the first direction,
the sixth nozzle row includes the first nozzle as the first nozzles and the second nozzle as the second nozzles,
in the sixth nozzle row, the first nozzles and the second nozzles are alternately positioned at the predetermined spacing distance along the first direction,
one of the first nozzle and the second nozzle is located at an end on one side in the first direction of each of the first nozzle row and the second nozzle row,
the other of the first nozzle and the second nozzle is located at an end on the one side in the first direction of each of the fifth nozzle row and the sixth nozzle row,
the fourth nozzle row group includes a seventh nozzle row and an eighth nozzle row each of which is formed along the first direction and which are adjacent to each other in the third direction,
the seventh nozzle row includes the fourth nozzle as the fourth nozzles which are positioned at the predetermined spacing distance along the first direction,
the eighth nozzle row includes the third nozzle as the third nozzles which are positioned at the predetermined spacing distance along the first direction,
the third nozzle row is adjacent to one side in the third direction of the fourth nozzle row,
the seventh nozzle row is adjacent to the one side in the third direction of the eighth nozzle row, and
the first nozzles and the second nozzles included in the first nozzle row, the first nozzles and the second nozzles included in the second nozzle row, the third nozzles included in the third nozzle row, the fourth nozzles included in the fourth nozzle row, the first nozzles and the second nozzles included in the fifth nozzle row, the first nozzles and the second nozzles included in the sixth nozzle row, the fourth nozzles included in the seventh nozzle row, and the third nozzles included in the eighth nozzle row are mutually different in positions in the first direction.

5. The liquid droplet ejecting apparatus according to claim 4, wherein the nozzles include both the third nozzle row group and the fourth nozzle row group.

6. The liquid droplet ejecting apparatus according to claim 1, wherein the first nozzle, the second nozzle, and the third nozzle are positioned on a same straight line along the first direction.

7. The liquid droplet ejecting apparatus according to claim 6, further comprising a carriage having the channel member and the driving elements mounted thereon and configured to reciprocate in a third direction parallel to the ejection surface and orthogonal to the first direction.

8. The liquid droplet ejecting apparatus according to claim 2, wherein
the nozzles further include a third nozzle row group and a fourth nozzle row group disposed side by side with the first nozzle row group and the second nozzle row group in the third direction,
the channel member has: a first common channel through which a liquid of a first color is to flow; and a second common channel through which a liquid of a second color different from the first color is to flow, as the common channel,
the first nozzle row group and the second nozzle row group communicate with the first common channel,
the third nozzle row group and the fourth nozzle row group communicate with the second common channel,
the third nozzle row group includes a fifth nozzle row and a sixth nozzle row each of which is formed along the first direction and which are adjacent to each other in the third direction,
the fifth nozzle row includes the first nozzle as the first nozzles and the second nozzle as the second nozzles,
in the fifth nozzle row, the first nozzles and the second nozzles are alternately positioned at the predetermined spacing distance along the first direction,
the sixth nozzle row includes the first nozzle as the first nozzles and the second nozzle as the second nozzles,
in the sixth nozzle row, the first nozzles and the second nozzles are alternately positioned at the predetermined spacing distance along the first direction,
one of the first nozzle and the second nozzle is positioned at an end on one side in the first direction of each of the first nozzle row and the second nozzle row,
the other of the first nozzle and the second nozzle is positioned at an end on the one side in the first direction of each of the fifth nozzle row and the sixth nozzle row,
the fourth nozzle row group includes a seventh nozzle row and an eighth nozzle row each of which is formed along the first direction and which are adjacent to each other in the third direction,
the seventh nozzle row includes the fourth nozzle as the fourth nozzles which are positioned at the predetermined spacing distance along the first direction,
the eighth nozzle row includes the third nozzle as the third nozzles which are positioned at the predetermined spacing distance along the first direction,
the third nozzle row is adjacent to the fourth nozzle row on one side in the third direction,
the seventh nozzle row is adjacent to the eighth nozzle row on the one side in the third direction,
the first nozzles and the second nozzles included in the first nozzle row, the first nozzles and the second nozzles included in the second nozzle row, the third nozzles included in the third nozzle row, and the fourth nozzles included in the fourth nozzle row are mutually different in positions in the first direction,
the first nozzles and the second nozzles included in the fifth nozzle row, the first nozzles and the second nozzles included in the sixth nozzle row, the fourth nozzles included in the seventh nozzle row, and the third nozzles included in the eighth nozzle row are mutually different in positions in the first direction, and
positions in the first direction are same, respectively, the first nozzle row and the fifth nozzle row are the same in positions in the first direction, the second nozzle row and the sixth nozzle row are the same in positions in the first direction, the third nozzle row and the seventh nozzle row are the same in positions in the first direction, and the fourth nozzle row and the eighth nozzle row are the same in positions in the first direction.

9. The liquid droplet ejecting apparatus according to claim 1, wherein the controller is configured to change at least one of an order of driving of the first driving element and the second driving element, an order of driving of the third driving element and the fourth driving element, and the predetermined amount of time, based on a predetermined condition.

10. The liquid droplet ejecting apparatus according to claim 1, wherein
the third nozzle is the first nozzle,
the third individual channel is the first individual channel,
the third connection port is the first connection port, and
the third driving element is the first driving element.

11. A liquid droplet ejecting method to be executed by a controller of a liquid droplet ejecting apparatus,
the liquid droplet ejecting apparatus including:
a channel member having an ejection surface in which nozzles are opened, individual channels, and a common channel;
driving elements fixed to the channel member; and
the controller electrically connected to the driving elements,
the nozzles including a first nozzle and a second nozzle which are adjacent to each other along a first direction parallel to the ejection surface, and a third nozzle and a fourth nozzle which are adjacent to each other along a second direction parallel to the ejection surface and crossing the first direction,
the individual channels including a first individual channel communicating with the first nozzle, a second individual channel communicating with the second nozzle, a third individual channel communicating with the third nozzle, and a fourth individual channel communicating with the fourth nozzle,
the common channel having a first connection port connected to the first individual channel, a second connection port connected to the second individual channel, a third connection port connected to the third individual channel, and a fourth connection port connected to the fourth individual channel,
the driving elements including a first driving element corresponding to the first nozzle, a second driving element corresponding to the second nozzle, a third driving element corresponding to the third nozzle, and a fourth driving element corresponding to the fourth nozzle, and
a distance between the first connection port and the second connection port being different from a distance between the third connection port and the fourth connection port,
the method comprising:
driving the first driving element and the third driving element at a first timing, without driving the second driving element and the fourth driving element; and
driving the second driving element and the fourth driving element at a second timing delayed by a predetermined amount of time from the first timing, without driving the first driving element and the third driving element.
